(19) United States
(12) Patent Application Publication
(10) Pub. No.: US 2025/0285490 A1
(43) Pub. Date: Sep. 11, 2025

(54) QUICK-FROZEN NOODLE UNFREEZING, COOKING AND VENDING MACHINE

(71) Applicant: YO-KAI EXPRESS INC., HAYWARD, CA (US)

(72) Inventors: Xiong XU, Zhejiang (CN); Chih-Hung LIN, Hayward, CA (US)

(73) Assignee: YO-KAI EXPRESS INC., HAYWARD, CA (US)

(21) Appl. No.: 18/858,644

(22) PCT Filed: Jun. 20, 2023
(86) PCT No.: PCT/US2023/068734

§ 371 Date: Oct. 21, 2024

(30) Foreign Application Priority Data
Apr. 20, 2022 (CN) 202210415367.4

(51) Int. Cl. G07F 17/00; A23B 2/82; A23L 7/109; G07F 9/10; G07F 11/54

(52) U.S. Cl. CPC G07F 17/0085; G07F 9/105; G07F 11/54; A23B 2/82; A23L 7/111

(57) ABSTRACT

The present application discloses a quick-frozen noodle un-freezing, cooking and vending machine, including a cabinet, a freezer chest and a mechanical arm. The cabinet is provided with a product dispenser port. The freezer chest is disposed in the cabinet. The mechanical arm is disposed in the cabinet. The cabinet is provided with a product dispenser door. A steam boiler, a water storage mechanism and an injection rod are further included. The steam boiler is disposed in the cabinet. The water storage mechanism is disposed in the cabinet and is connected to the steam boiler. The injection rod is movably disposed in the cabinet. The present invention provides the following effects: quick-frozen noodles are unfreezed by steam, moisture in the noodles is not lost during the unfreezing process, and the unfreezed noodles have good elasticity and provide good texture for chewing.

### CROSS REFERENCE TO RELATED APPLICATIONS

This application is the National Phase of PCT International Application No. PCT/US2023/068734, filed on Jun. 20, 2023, which claims priority under 35 U.S.C. 119(a) to Patent Application No. 202210415367.4, filed in China on Apr. 20, 2022, all of which are hereby expressly incorporated by reference into the present application.

### BACKGROUND OF THE INVENTION

### Field of the Invention

The present invention relates to the field of automatic vending machines, and more particularly to a quick-frozen noodle unfreezing, cooking and vending machine.

### Description of the Prior Art

There are current an increasing number of places where automatic vending machines are used. The Patent Publication No. CN 211087380 U discloses an unmanned quick-frozen noodle unfreezing, cooking and vending machine. Such unmanned vending machine heats pre-frozen noodles by a microwave oven and then sells the noodles during vending. In the above vending machine, heating is performed by using a microwave oven. In the heating process of the microwave oven, molecules inside food within a certain range are vibrated at a high frequency generated by magnetic control, such that heat is produced inside food ingredients. Thus, original moisture in noodles may be lost from such noodles heated by the microwave oven. Once the moisture is lost, soup later added to soak the noodles still cannot restore the original elasticity of the noodles, for the reasons below. When flour and water are mixed during the process of noodles making, gliadin and glutenin gradually absorb water and swell, stick to each other, and form a continuous film-like matrix and cross-link each other, hence forming a three-dimensional gluten network structure with certain elasticity, extensibility, viscosity and plasticity. During the heating process of the microwave oven, the moisture in the noodles leaves the noodles, dehydrating the gliadin and glutenin, and destroying the gluten network structure. Even if the hot soup is added later, the gluten network structure in the noodles cannot be formed again. As a result, things heated by a microwave oven may taste rather dry, and more particularly for noodles, such loss of moisture from the noodles degrades the texture for chewing of the noodles.

### SUMMARY OF THE INVENTION

In response to the issues above, the present invention provides a quick-frozen noodle unfreezing, cooking and vending machine.

The technical solutions of the present invention are as follows.

A quick-frozen noodle unfreezing, cooking and vending machine, includes a cabinet, a freezer chest and a mechanical arm. The cabinet is provided with a product dispenser port. The freezer chest is disposed in the cabinet. The mechanical arm is disposed in the cabinet. The cabinet is provided with a product dispenser door. A steam boiler, a water storage mechanism and an injection rod are further included. The steam boiler is disposed in the cabinet. The water storage mechanism is disposed in the cabinet, and is connected to the steam boiler. The injection rod is movably disposed in the cabinet.

In the vending machine, the steam boiler, the water storage mechanism and the injection rod are provided. After the mechanical arm takes out a cup or bowl of the quick-frozen noodles from the freezer chest, the steam boiler heats the water provided by the water storage tank, heats the water into steam, and inputs the steam into the injection rod. The injection rod then moves and pierces a cover of the cup or bowl of the quick-frozen noodles. The steam is injected to the cup or bowl of the quick-frozen noodles through the injection rod, and the quick-frozen noodles are unfreezed by the steam. Compared to unfreezing by using a microwave oven, the present vending machine uses steam for unfreezing. Thus, during the unfreezing process, moisture is not lost from the noodles, and the unfreezed noodles are preserved with good elasticity and provide better texture for chewing. Moreover, in the present vending machine, quick-frozen noodles are unfreezed by steam. Compared to unfreezing in hot water, unfreezing by steam is performed in a relatively dry environment, and the noodles are less likely to form a clot during the unfreezing process.

More specifically, a stepping motor is fixedly installed in the cabinet, the injection rod is a hard injection rod (which may be made of metal), the injection rod is installed on a shaft of the stepping motor, the shaft of stepping motor is telescopic so as to drive the injection rod to move, and the injection rod and the steam boiler are connected by a flexible metal pipe.

A hot water boiler is selectively further included. The hot water boiler is connected to the water storage mechanism, and the hot water boiler is also connected to the injection rod.

The function of the hot water boiler is to perform heating by using the water stored in the water storage mechanism, and hot water is then added to the unfreezed the noodles to form soup noodles in the cup or bowl. More specifically, the hot water boiler and the injection rod are connected by a flexible metal pipe. Both of the hot water boiler and the steam boiler are installed with electromagnetic valves, and the electromagnetic valves control by switches thereof whether hot water or steam can enter the injection rod.

More specifically, the water storage mechanism is a water barrel. The water storage mechanism is connected to the steam boiler and the hot water boiler via a water pump. The water pump transports the water stored in the water storage mechanism into the steam boiler or the hot water boiler.

A waste water collection mechanism is selectively further included. The waste water collection mechanism is disposed on one side of the injection rod.

The waste water collection mechanism is for collecting waste water generated from cleaning the injection rod. The cleaning of the injection rod includes exterior cleaning and interior cleaning. More specifically, the waste water collection mechanism includes a funnel and a waste water collection tank. Both the funnel and the waste water collection tank are fixedly disposed in the cabinet. One end of the funnel is located in the waste water collection tank, and waste water collected by the funnel directly enters the waste water collection tank.

The freezer chest is selectively provided with a product shelf.

The function of the product shelf is for storing cups or bowls of quick-froze noodles.

More specifically, the product shelf includes a rotating post and a plurality of bowl noodles supports, the bowl noodles supports are disposed on the rotating post, and the rotating post is rotationally disposed in the cabinet. A motor for driving the rotating post to rotate is installed in the cabinet. The bowl noodles supports are arranged and distributed on the rotating post, and the function of the bowl noodles supports is to clamp and hold the cup or bowl of quick-froze noodles. During use, the quick-frozen noodles are held on the cup or bowl supports, and the rotating post rotates the bowl noodles supports to the mechanical arm by means of the rotation thereof for the mechanical arm to readily pick up the product.

The cabinet is provided with a noodles cooking chamber therein. The noodles cooking chamber is located on one side of the product dispenser port.

More specifically, the function of the noodles cooking chamber is to place the quick-frozen noodles. More specifically, the noodles cooking chamber is square tubular in shape, and a hole is provided on a chamber wall of the noodles cooking chamber. The injection rod can enter the noodles cooking chamber via the hole on the chamber wall of the noodles cooking chamber, such that the injection rod is readily to inject steam or hot water into the cup or bowl of the quick-frozen noodles.

More specifically, a push plate is installed on one side of the noodles cooking chamber by a motor or a cylinder, and the function of the motor or the cylinder is to push the push plate to move. When the cups or bowls of the quick-frozen noodles are taken out by the mechanism arm from the freezer chest, the motor or the cylinder pushes the push plate to move to forward the cup or bowl of the quick-frozen noodles into the noodles cooking chamber. After the noodles are completely unfreezed and heated, the push plate continues to push the cup or bowl of the noodles until the noodles are pushed out of the noodles cooking chamber (that is, the product dispenser port of the cabinet). A water leak hole is provided on one side of the chamber hole of the noodles cooking chamber. The funnel is disposed outside the noodles cooking chamber, and the funnel is located below the water leak hole. The waste water produced during the unfreezing and heating process directly enters the funnel via the water leak hole, and then enters the waste water collection tank after entering the funnel.

A lift guide rail is further selectively included. The lift guide rail is installed in the cabinet, and the mechanical arm is installed on the lift guide rail.

More specifically, the mechanical arm includes an installation board, a rotating motor and a mechanical arm. The rotating motor is fixed on the installation board, the mechanical arm is fixed on a shaft of the rotating motor, and the installation board is installed on the lift guide rail. A lift motor is installed in the cabinet. The lift motor is connected to the installation board by a timing belt, and the lift motor enables, by means of winding or unwinding of the timing belt, the installation board to slide along the lift guide rail. In an alternative implementation means, a lead screw may be used in substitution for the lift guide rail, and the installation board is directly fixed on a slider of the lead screw. When a motor of the lead screw functions, a shaft of the lead screw may be driven to thereby moving the installation board along with the slider.

A control host is further selectively included. The control host is disposed in the cabinet, the control host is electrically connected to the mechanical arm, the freezer chest and the steam boiler.

More specifically, the freezer chest, the steam boiler, the hot water boiler, the electromagnetic valves, the various motors and the various electric cylinders are operated and controlled by the control host.

The freezer chest is selectively provided with an entrance/exit, and an insulation door is slidably installed on an outer wall of the freezer chest.

More specifically, the insulation door is slidably installed on an outer wall of the freezer chest by a wheel and a guide rail, and a switch door motor is further installed on the insulation door. The switch door motor and the wheel operate in cooperation. The switch door motor enables, by means of driving the wheel, the insulation door to move on the outer wall of the freezer chest, thereby closing or opening the entrance/exit by the insulation door. When the entrance/exit is open, the mechanical arm forwards the cup or bowl of the quick-frozen noodles out of the freezer chest, and then closes the insulation door.

In another embodiment of the present invention, the cabinet for cooking the noodle is outside the vending machine. After a cup or bowl of the quick-frozen noodles is taken outside from the freezer chest, the cut or bowl of the quick-frozen noodles is put in the cabinet outside the vending machine for unfreezing and cooking.

In one example of the invention, the cabinet is a heating device, which comprises

In one example of the invention, there is a plurality of heating coils, and the heating coils are spaced from one another and are uniformly distributed in the water container.

In one example, there is a plurality of microwave elements, and the microwave elements are spaced from one another and are uniformly distributed in the housing.

In one further aspect, the vending machine further comprises a interactive system for controlling the cooking method and cashless vending. The sustem comprises a payment interface, which is accessible y a user and mounts on an eternal surface of the vending machine; the payment interface further comprises a magnetic card payment interface, a disply, a first interactive interface; and an enclosure, said magnetic card payment interface, said display, and said first interactive interface are packaged in said enclosure; and a payment module, said payment module is not accessible to a user and is secured inside of said vending machine, said payment module further comprising a microcontroller;

a vending equipment interface interconnected with said microcontroller, said payment module, by way of said vending equipment interface, interconnects to and data communicates with a vending machine controller, said vending machine controller is interconnected with and controls said vending machine; and
a second interactive interface interconnected with said microcontroller, said second interactive interface interconnects said payment module to said tethered payment interface by way of said first interactive interface,
data communicated between said first interactive interface and said second interactive interface includes said magnetic card payment interface data, and said display data, based in part on data communicated between said payment interface and said payment module and data communicated between said payment module and said vending machine controller, said audit-credit-interactive system monitors said vending machine activity, and. selectively controls said vending machine vending cycles effectuating cashless vending.

The present invention provides the following effects: quick-frozen noodles are unfreezed by steam, moisture in the noodles is not lost during the unfreezing process, and the unfreezed noodles have good elasticity and provide good texture for chewing.

### BRIEF DESCRIPTION OF THE DRAWINGS

FIG. 1 is a brief schematic diagram of a quick-frozen noodle unfreezing, cooking and vending machine;

FIG. 2 is a brief schematic diagram of an internal structure of a cabinet;

FIG. 3 is a schematic diagram of a position relation between a push plate and a noodles cooking chamber;

FIG. 4 is a schematic diagram of a position relation between an injection rod and the noodles cooking chamber;

FIG. 5 is an enlarged view of part A in FIG. 4;

FIG. 6 is a brief schematic diagram of a structure of a freezer chest;

FIG. 7 is a brief schematic diagram of a structure of a mechanical arm; and

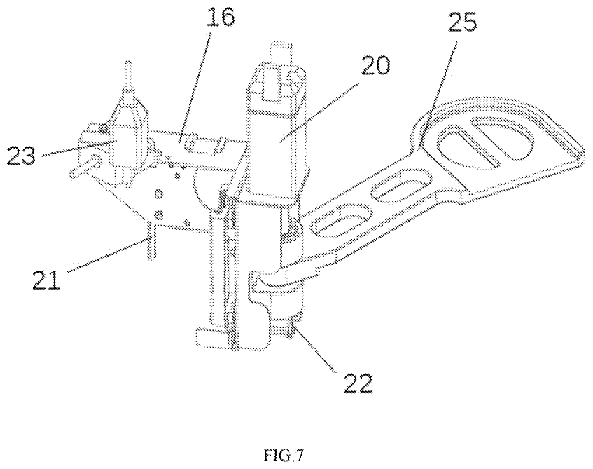

FIG. 8 is a schematic diagram of an installation relation of a steam boiler and a hot water boiler on a cabinet.

The numerals in the accompanying drawings are: 1: antenna; 2: control host; 3: product dispenser port; 4: rotating post; 5: bowl noodles support; 6: lift guide rail; 7: water barrel; 8: cabinet; 9: noodles cooking chamber; 10: cup quick-frozen noodles; 11: injection rod; 12: steam boiler; 13: hot water boiler; 14: push plate; 15: mechanical arm; 16: installation board; 17: refrigerator; 18: insulation door; 19: entrance/exit; 20: rotating motor; 21: photoelectric detector; 22: encoder; 23: scanner; 24: funnel; 25: waste water collection tank; 26: stepping motor; 27: protruding strip; 28: water leak hole; 29: water pump.

### DETAILED DESCRIPTION OF THE EMBODIMENTS

The present invention is described in detail with the accompanying drawings below.

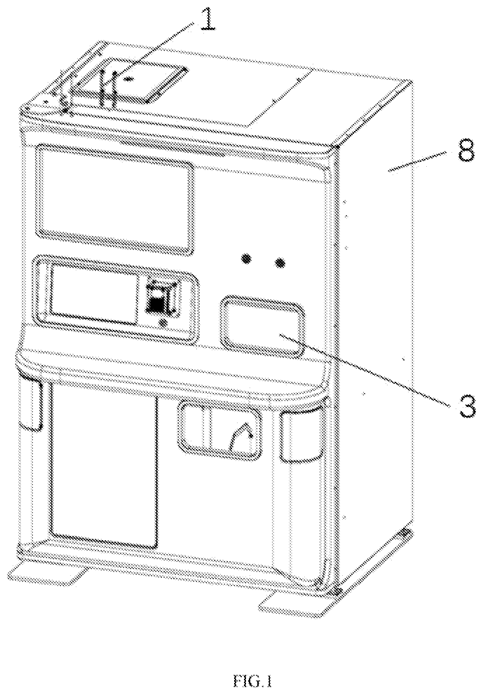

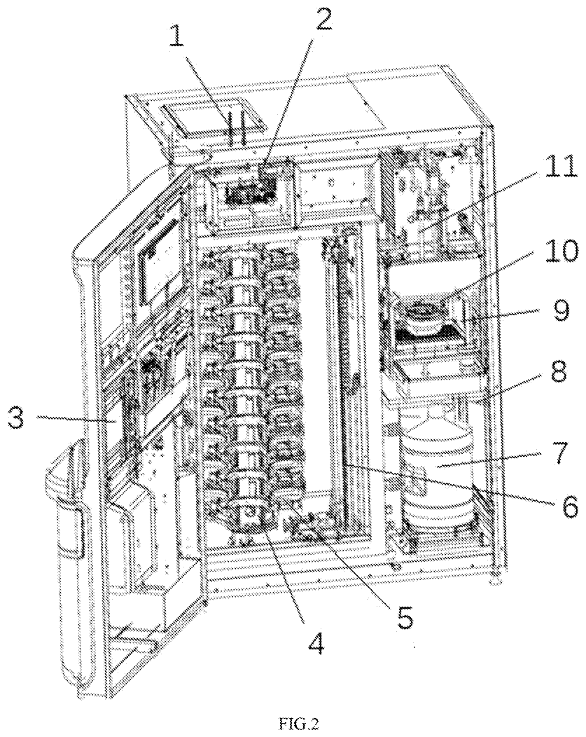

As shown in FIG. 1 and FIG. 2, a quick-frozen noodle unfreezing, cooking and vending machine includes a cabinet 8, a freezer chest and a mechanical arm. The cabinet 8 is provided with a product dispenser port 3. The freezer chest is disposed in the cabinet 8. The mechanical arm is disposed in the cabinet 8. The cabinet 8 is provided with a product dispenser door. A steam boiler 12, a water storage mechanism and an injection rod 11 are further included. The steam boiler 12 is disposed in the cabinet 8. The water storage mechanism is disposed in the cabinet 8, and is connected to the steam boiler 12. The injection rod 11 is movably disposed in the cabinet 8.

In the present vending machine, the steam boiler 12, the water storage mechanism and the injection rod 11 are provided. After the mechanical arm takes out cup quick-frozen noodles 10 from the freezer chest, the steam boiler 12 heats the water provided by the water storage tank, heats the added water into steam, and inputs the steam into the injection rod 11. The injection rod 11 then moves and pierces a cover of the cup quick-frozen noodles 10. The steam enters the cup of the quick-frozen noodles through the injection rod 11, and the quick-frozen noodles are unfreezed by the steam. Compared to unfreezing by using a microwave oven, the present vending machine uses steam for unfreezing. Thus, during the unfreezing process, moisture is not lost from the noodles, and the unfreezed noodles are preserved with good elasticity and provide better texture for chewing. Moreover, in the present vending machine, quick-frozen noodles are unfreezed by steam. Compared to unfreezing in hot water, unfreezing by steam is performed in a relatively dry environment, and the noodles are less likely to form a clot during the unfreezing process.

More specifically, in this embodiment, a freezer chest with a temperature of minus 23 degrees Celsius is selected as the freezer chest. At this low temperature, most microorganisms cannot carry out growth and reproduction activities, and the cup quick-frozen noodles 10 can have a longer preservation time.

More specifically, a stepping motor 26 is fixedly installed in the cabinet 8, the injection rod 11 is a hard injection rod (which may be made of metal, for example, a 304 stainless steel pipe), the injection rod 11 is installed on a shaft of the stepping motor 26, the shaft of the stepping motor 26 can drive the injection rod Il to move, and the injection rod 11 and the steam boiler 12 are connected by a flexible metal pipe in between.

More specifically, in this embodiment, the steam boiler 12 heats water to 140 degrees Celsius, and then passes the steam into the cup quick-frozen noodles 10 for unfreezing.

The cup quick-frozen noodles 10 includes a cup (which may be made of paper, or may be made of heat resistant plastic) and a film (a composite film of paper and a polypropylene plastic film), the noodles are placed in the cup, a film cover is located on a cup opening of the cup, and the film can be pierced by the injection rod 11.

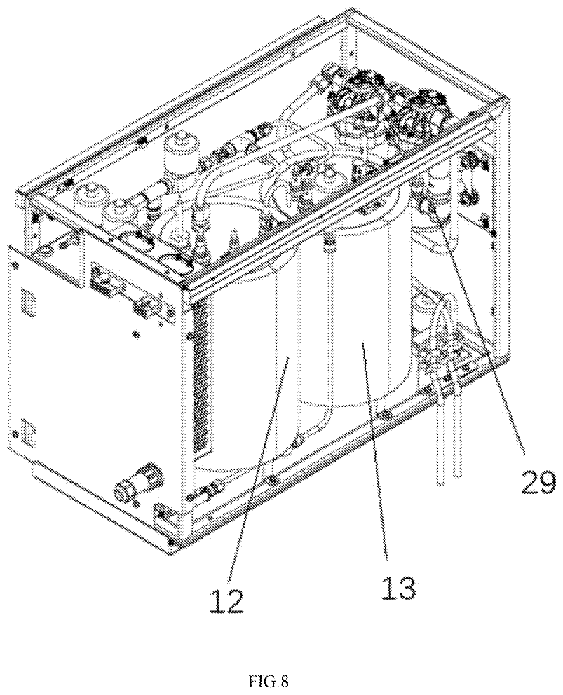

As shown in FIGS. 1, 2 and 8, a hot water boiler 13 is further included. The hot water boiler 13 is connected to the water storage mechanism, and the hot water boiler 13 is also connected to the injection rod 11.

The function of the hot water boiler 13 is to perform heating by using the water stored in the water storage mechanism, and hot water is then added to the unfreezed cup noodles to form soup noodles. More specifically, the hot water boiler 13 and the injection rod 11 are connected by a flexible metal pipe in between. Both of the hot water boiler 13 and the steam boiler 12 are installed with electromagnetic valves, and the electromagnetic valves control by switches thereof whether hot water or steam can enter the injection rod 11.

More specifically, the water storage mechanism can be a water barrel 7. The water storage mechanism is connected to the steam boiler 12 and the hot water boiler 13 via a water pump 29. The water pump 29 transports the water stored in the water storage mechanism into the steam boiler 12 or the hot water boiler 13.

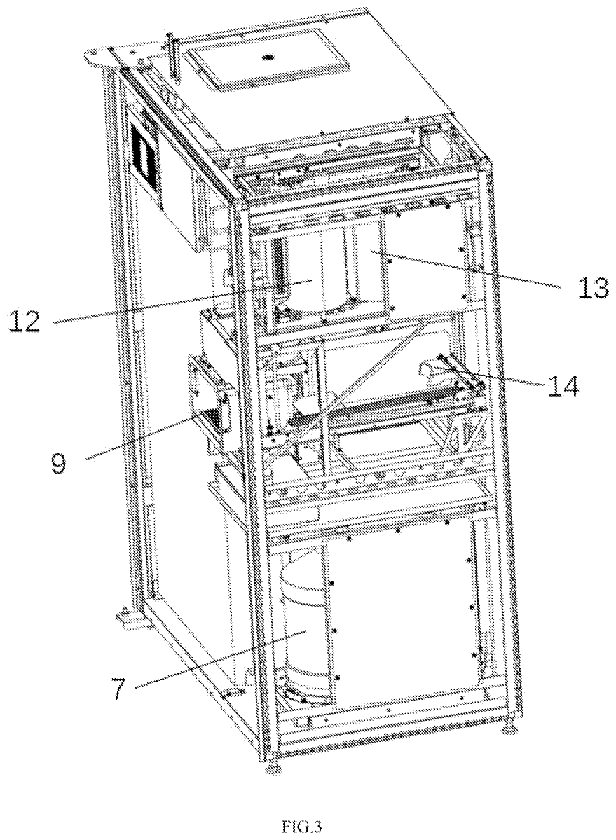

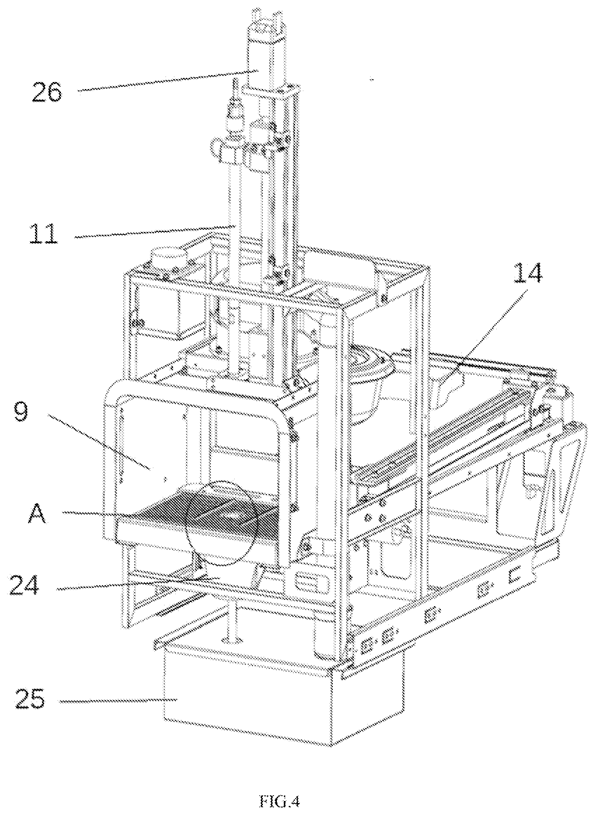

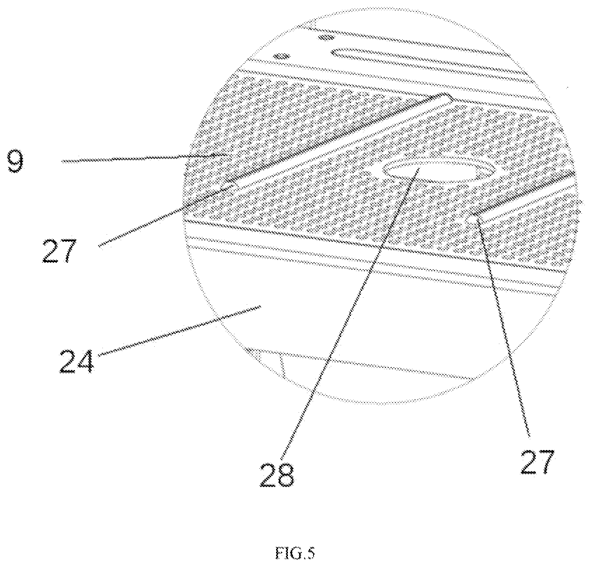

As shown in FIGS. 1, 2, 3, 4 and 5, a waste water collection mechanism is selectively further included. The waste water collection mechanism is disposed on one side of the injection rod 11.

The reason for the above is that, when steam and hot water are injected into the cup noodles, the waste water mechanism is used for collecting overflown water produced during the process of injecting the steam and injecting the hot water. More specifically, the waste water collection mechanism includes a funnel 24 and a waste water collection tank 25. Both the funnel 24 and the waste water collection tank 25 are fixedly disposed in the cabinet 8. One end of the funnel 24 is located in the waste water collection tank 25, and waste water collected by the funnel 24 directly enters the waste water collection tank 25.

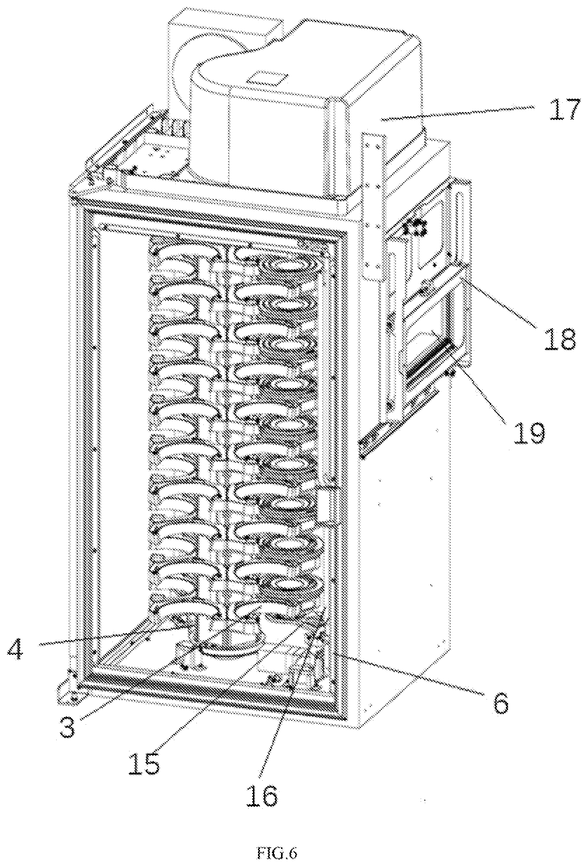

As shown in FIGS. 2 and 6, the freezer chest is provided therein with a product shelf.

The function of the product shelf is used for storing the cup quick-froze noodles 10.

More specifically, the product shelf includes a rotating post 4 and a plurality of bowl noodles supports 5, the bowl noodles supports 5 are disposed on the rotating post 4, and the rotating post 4 is disposed in the cabinet 8. A motor for driving the rotating post 4 to rotate is installed in the cabinet 8. The bowl noodles supports 5 are arranged and distributed on the rotating post 4, and the function of the bowl noodles supports 5 is used to clamp and hold the cup quick-froze noodles 10. During use, the quick-frozen noodles are held on the bowl noodles supports 5, and the rotating post 4 rotates the bowl noodles supports 5 to the mechanical arm by means of the rotation thereof for the mechanical arm to readily pick up the product.

As shown in FIGS. 2, 3, 4 and 5, the cabinet 8 is provided therein with a noodles cooking chamber 9. The noodles cooking chamber 9 is located on one side of the product dispenser port 3.

More specifically, the function of the noodles cooking chamber 9 is used for placing the cup quick-frozen noodles 10. More specifically, the noodles cooking chamber 9 is square tubular in shape, and a hole is provided on a chamber wall of the noodles cooking chamber 9. The injection rod 11 can enter the noodles cooking chamber 9 via the hole on the chamber wall of noodles cooking chamber 9, such that the injection rod 11 is readily to pass steam or hot water into the cup quick-frozen noodles 10.

More specifically, a push plate 14 is installed on one side of the noodles cooking chamber 9 by a motor or a cylinder, and the function of the motor or the cylinder is to push the push plate 14 to move. When the cup quick-frozen noodles 10 are taken out by the mechanism arm from the freezer chest, the motor or the cylinder pushes the push plate 14 to move to forward the cup quick-frozen noodles 10 into the noodles cooking chamber 9. After the noodles are completely unfreezed and heated, the push plate 14 continues to push the cup noodles until the cup noodles are pushed out of the noodles cooking chamber 9 (that is, the product dispenser port 3 of the cabinet 8). More specifically, a water leak hole 28 is provided on the chamber wall of the bottom of the noodles cooking chamber 9, and two protruding strips 28 are further provided on the bottom of the noodles cooking chamber 9, wherein the two protruding strips 27 are parallel. When the cup quick-frozen noodles 10 are placed on the noodles cooking chamber 9, the cup quick-frozen noodles 10 are in contact with the protruding strips 27 but are not in contact with the bottom of the noodles cooking chamber 9, thus ensuring the cup quick-frozen noodles 10 are not frozen on the noodles cooking chamber 9 during the process that the push plate 14 pushes the cup quick-frozen noodles 10 to the noodles cooking chamber 9. During the heating process of the cup quick-frozen noodles 10, water drops inevitably remain on the bottom. Thus, if the cup quick-frozen noodles 10 (having a temperature of minus 23 degrees Celsius at the instant of being taken out of the freezer chest), the cup quick-frozen noodles 10 having a temperature of minus 23 degrees Celsius are frozen and fixed on the noodles cooking chamber 9 at the instant of touching the water. Therefore, the protruding strips 27 are disposed. The protruding strips 27 are semicircular in shape, and are not attached with any water drops, hence ensuring that the cup quick-frozen noodles 10 are not frozen on the protruding strips 27 during the unfreezing process of the cup quick-frozen noodles 10.

More specifically, the funnel 24 is disposed outside the noodles cooking chamber 9, and the funnel 24 is located below the water leak hole 28. The waste water produced during the unfreezing and heating process directly enters the funnel 24 via the water leak hole 28, and then enters the waste water collection tank 25 after entering the funnel 24.

As shown in FIGS. 2 and 6, a lift guide rail 6 is further included. The lift guide rail 6 is installed in the cabinet 8, and the mechanical arm is installed on the lift guide rail 6.

More specifically, the mechanical arm includes an installation board 16, a rotating motor and a mechanical arm 15. The rotating motor is fixed on the installation board 16, the mechanical arm 15 is fixed on a shaft of the rotating motor, and the installation board 16 is installed on the lift guide rail 6. A lift motor is installed in the cabinet 8. The lift motor is connected to the installation board 16 by a timing belt, and the lift motor enables, by means of winding or unwinding of the timing belt, the installation board 16 to slide along the lift guide rail 6. In an alternative implementation means, a lead screw may be used in substitution for the lift guide rail 6, and the installation board 16 is directly fixed on a slider of the lead screw. When a motor of the lead screw functions, a shaft of the lead screw may be driven to thereby moving the installation board 16 along with the slider.

More specifically, a photoelectric detector 21 is further installed on the installation board 16, and the photoelectric detector 21 is used for detecting the position of the rotating mechanical arm. Meanwhile, a scanner 23 is further installed on the installation board 16, and the function of the scanner 23 is to scan barcode information of the cup quick-frozen noodles 10. An encoder 22 is further connected on the rotating motor, and the encoder 22 can perform coded control on the rotating motor.

As shown in FIGS. 1 and 2, a control host 2 is further included. The control host 2 is disposed in the cabinet 8, and the control host 2 is electrically connected to the mechanical arm, the freezer chest and the steam boiler 12.

More specifically, the freezer chest, the steam boiler 12, the hot water boiler 13, the electromagnetic valves, the various motors and the various electric cylinders are operated and controlled by the control host 2.

As shown in FIG. 6, an entrance/exit 19 is provided on the freezer chest, and an insulation door 18 is slidably installed on an outer wall of the freezer chest.

More specifically, the insulation door 18 is slidably installed on an outer wall of the freezer chest by a wheel and a guide rail, and a switch door motor is further installed on the insulation door 18. The switch door motor and the wheel operate in cooperation. The switch door motor enables, by means of driving the wheel, the insulation door 18 to move on the outer wall of the freezer chest, thereby closing or opening the entrance/exit 19 by the insulation door 18. When the entrance/exit 19 is open, the mechanical arm forwards the cup quick-frozen noodles out of the freezer chest, and then closes the insulation door 18.

More specifically, in this embodiment, an electrical apparatus (for example, a motor) installed in the freezer chest is enveloped by an insulation cotton layer. Moreover, to further prevent frost from being produced in the freezer chest, a de-watering mechanism is further provided in the freezer chest to ensure an anhydrous environment in the freezer chest and avoid freezing in the freezer chest.

More specifically, on the vending machine provided by this embodiment, the control host is built-in with a wireless communication module. The wireless communication module in the control host is connected to an antenna 1 (the antenna 1 is located outside the cabinet 8) and is used for communicating with a cell phone or other electronic apparatuses, and a user can purchase noodles on the present vending machine by using an electronic apparatus such as a cell phone.

It should be noted that the preferred embodiments of the present invention are described above for illustration purposes and are not to be construed as limitations to the scope of the claims of the present invention. All equivalent modifications made on the basis of the description of the present invention and directly or indirectly applied to other related technical fields are to be similarly encompassed within the scope of protection of the present invention.

1-16. (canceled)

17. A quick-frozen noodle unfreezing, cooking and vending machine, comprising a cabinet, a freezer chest and a mechanical arm, wherein the cabinet is provided with a product dispenser port, the freezer chest is disposed in the cabinet, the mechanical arm is disposed in the cabinet, the cabinet is provided with a product dispenser door; the quick-frozen noodle unfreezing, cooking and vending machine being characterized in further comprising a steam boiler, a water storage mechanism, a stepping motor and an injection rod, wherein the steam boiler is disposed in the cabinet, the water storage mechanism is disposed in the cabinet and is connected to the steam boiler, the stepping motor is disposed in the cabinet, the injection rod is disposed on a shaft of the stepping motor, and the steam boiler is connected to the injection rod.

18. The quick-frozen noodle unfreezing, cooking and vending machine according to claim 17, being characterized in further comprising a hot water boiler and a water pump, wherein the hot water boiler is connected to the water storage mechanism via the water pump, and the hot water boiler is connected to the injection rod.

19. The quick-frozen noodle unfreezing, cooking and vending machine according to claim 17, being characterized in that, the cabinet is provided therein with a noodles cooking chamber, and the noodles cooking chamber is located on one side of the product dispenser port.

20. The quick-frozen noodle unfreezing, cooking and vending machine according to claim 19, being characterized in further comprising a funnel and a waste water collection tank, wherein a water leak hole is provided over the noodles cooking chamber, the funnel and the waste water collection tank are both disposed in the cabinet, and the funnel is located outside the noodles cooking chamber.

21. The quick-frozen noodle unfreezing, cooking and vending machine according to claim 19, being characterized in that, the cabinet is provided therein with a push plate, and the push plate is located on one side of the noodles cooking chamber.

22. The quick-frozen noodle unfreezing, cooking and vending machine according to claim 17, being characterized in that, the cabinet is provided therein with a rotating post, and bowl noodles supports are disposed on the rotating post.

23. The quick-frozen noodle unfreezing, cooking and vending machine according to claim 17, being characterized in further comprising a lift guide rail, wherein the lift guide rail is installed in the cabinet, and the mechanical arm is installed on the lift guide rail.

24. The quick-frozen noodle unfreezing, cooking and vending machine according to claim 17, being characterized in further comprising a control host, wherein the control host is disposed in the cabinet, the control host is electrically connected to the mechanical arm, the freezer chest and the steam boiler, and an antenna is connected on the control host.

25. The quick-frozen noodle unfreezing, cooking and vending machine according to claim 17, being characterized in that, an entrance/exit is provided on the freezer chest, and an insulation door is slidably installed on an outer wall of the freezer chest.
